(19) United States
(12) Patent Application Publication
(10) Pub. No.: US 2006/0251046 A1
(43) Pub. Date: Nov. 9, 2006

(54) Master-slave synchronization communication method

(75) Inventor: Noboru Fujiwara, Fukuoka (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHA YASKAWA DENKI

(21) Appl. No.: 10/565,650

(22) PCT Filed: Jun. 10, 2004
(86) PCT No.: PCT/JP04/08122

§ 371 Date: Jan. 24, 2006

(30) Foreign Application Priority Data
Jul. 24, 2003 (JP) 2003-279358

(51) Int. Cl. H04J 3/06

(52) U.S. Cl. 370/350

(57) ABSTRACT

A master/slave synchronization communication system applies IEEE1394, and uses its natural period as a base cycle so as to provide synchronization of all stations with a communication period as an integral multiple of the base cycle, thereby allowing easy scheduling of data transmission/reception. The master/slave synchronization communication system has a communication period which is set to an integral multiple of a natural period of IEEE1394 communications with the natural period considered as a base cycle, each station has a detecting section of a synchronization point being a start timing of the communication period, and a base cycle counter which shows what base cycle number the present cycle is from the synchronization point (The counter value has the same value at all stations after detecting the synchronization point), the master transmits instruction data to each slave based on a transmission management table in which destination slaves of instruction data are previously allocated to each of the base counter values, and each of the slaves transmits response data to the master based on transmission timing information which sets the base cycle counter value where a response is transmitted.

### BACKGROUND OF THE INVENTION

1. Field of the Invention

The present invention relates to a communication system for a real-time control system that performs master/slave synchronization communications by using IEEE1394.

2. Description of the Related Art

In a related art of the master/slave synchronization communication system, similar to PROFIBUS-DP, a master simultaneously broadcasts a data packet notifying the synchronization point of a communication period and each slave detects the synchronization point with its reception timing, and instruction data is thereafter exchanged with response data by way of polling (For example, refer to Non-patent Publication 1.).

In another system such as SERCOS (Registered Trademark), a master simultaneously broadcasts a data packet notifying the synchronization point of a communication period and then transmits instruction data to each slave while each slave sequentially transmits response data after a predetermined period has elapsed since the synchronization point or based on a predetermined transmission order (For example, refer to Non-patent Publication 2.).

Such a system where a master and slaves communicate with each other in synchronization is a general communication system used in a real-time control system.

An IEEE1394-compatible network is a high-speed general-purpose network generally used by a personal computer or an AV device. Its transmission speed is 100 Mbps to 3.2 Gbps, which ensures extremely high-speed communications compared with PROFIBUS-DP whose highest speed is 12 Mbps and SERCOS whose highest speed is 16 Mbps. The IEEE1394-compatible network has features not available from the Ethernet (Registered Trademark) which is also a general-purpose high-speed network: isochronous communications are supported where all nodes connected to the network operate at a natural period of 125 μs. Application of such a network to a network for real-time control that performs the master-slave synchronization communication is expected (For example, refer to Patent Publication 1.).

FIG. 12 shows a communication time chart of a communication system generally used in PROFIBUS-DP or the like. In FIG. 12, signs c1, c2, . . . represent instruction data timings a slave #1, a slave #2, and so on while signs r1, r2, . . . represent response data transmission timings from the slave #1, the slave #2, and so on. As shown in FIG. 12, a synchronous packet is simultaneously broadcast at a synchronization point at the head of a communication period and then instruction data is transmitted to the slave #1, slave #2, and so on. On receiving the instruction data, the slave #1 returns response data. On receiving the instruction data, the slave #2 returns response data. In this process of so-called polling, instruction data and response data are transmitted/received until another synchronization point is reached after the communication period has elapsed when a synchronous packet is simultaneously broadcast.

FIG. 13 shows a communication time chart of another communication system employed in SERCOS or the like. As shown in FIG. 13, a synchronous packet is simultaneously broadcast at a synchronization point at the head of a communication period, same as the case in FIG. 12. Following this, instruction data c1, c2, . . . to be transmitted to the slaves is transmitted with a timing from the master, sometimes in a single packet. After a predetermined time value adjusted per slave has elapsed, the response data (r1, r2, . . . ) is transmitted until another synchronization point is reached after the communication period has elapsed when a synchronous packet simultaneously broadcast.

In this way, in the related art of the master/slave synchronization communication system, a synchronous packet is simultaneously broadcast at every synchronization point of a cc period in order to assure synchronization of all stations.

Patent Publication 1: JP-A-2003-008579

Non-patent Publication 1:PROFIBUS-DP Specification (IEC61158 Type3)

Non-patent Publication 2:SERCOS Specification (IEC61491)

### SUMMARY OF THE INVENTION

However, the related art of the master/slave synchronization communication system requires operation where a synchronous packet is simultaneously and accurately broadcast at every synchronization point from a master to notify each slave of a synchronization point. In the case where the isochronous communications of an IEEE1394-compatible network are applied in order to support this request, a cycle start packet edited and simultaneously transmitted per natural period is the most ideal synchronization point notification section although the packet does not guarantee the transmission timing accuracy thus causing jitter at a synchronization point.

Another problem with the related art of the master/slave synchronization communication system is that the natural period is fixed and cannot be modified even when it is necessary to provide a communication period longer than the natural period because of an increased number of slaves.

The isochronous communication of IEEE1394 is a communication system where packets are simultaneously transmitted with difficulty in adjustment of data transmission timing to the transmission path as well as no assurance of transmission order. This makes it difficult to perform polling used in the related art of the master/slave synchronization communication system or data transmission scheduling after a predetermined time since a synchronization point or in accordance with a data transmission order.

In the case of JP-A-2003-008579 cited as a related art, a unique trigger packet (synchronous packet) is simultaneously broadcast instead of a cycle start packet via isochronous communications and each slave performs data communications via asynchronous communications to make a transmission request from a master in order to secure a communication period across multiple isochronous cycles. This results in greater jitter. Moreover, switching between isochronous communications and asynchronous communications complicates communication processing in each station.

The invention has been accomplished in view of the problems. An object of the invention is to provide a master/slave synchronization communication system that applies IEEE1394, and uses its natural period as a base cycle so as to provide synchronization of all stations with a communication period as an integral multiple of the base cycle, thereby allowing easy scheduling of data transmission/reception.

In order to attain the object, the first invention described in claim 1 provides a master/slave synchronization communication system, having: a single master and a single or a plurality of slaves that are based on IEEE1394, wherein the master/slave synchronization communication system has a communication period which is set to an integral multiple of a natural period of IEEE1394 communications with the natural period considered as a base cycle, each of the master and the slaves has a detecting section of a synchronization point being a start timing of the communication period, and a base cycle counter which shows what base cycle number the present cycle is from the synchronization point, the master has a transmission management table in which destination slaves of instruction data are previously allocated to each of the base counter values and transmits instruction data to each slave every time the base cycle counter is updated based on the transmission management table, and each of the slaves transmits response data to the master when the pre-allocated value of the base cycle counter is reached.

In this way, it is possible to perform data communications based on a base cycle counter thereby performing synchronization communications scheduled on a per base cycle basis in a communication period that is longer than the base cycle.

A second invention described in claim 2 provides the master/slave synchronization communication system wherein as the detecting section of the synchronization point, the master determines an arbitrary base cycle as a synchronization point, and transmits instruction data to each slave based on the base cycle, and each of the slaves corrects a current value of the base cycle counter based on the base cycle counter value assumed when the instruction data is received and the pre-allocated base cycle counter value assumed when the instruction data is received, and detects a time as a synchronization point when the count value reaches a predetermined value. As a result, all the stations are kept synchronous even when the communication period between the master and the slave is an integral multiple of a base cycle.

A third invention described in claim 3 provides the master/slave synchronization communication system wherein as a separate detecting section for the synchronization point, the master determines an arbitrary base cycle as a synchronization point, and writes CYCLE_TIME register value as the next synchronization point in the instruction data when the master transmits instruction data to each slave based on the base cycle, and each of the slaves corrects a current value of the base cycle counter value based on the CYCLE_TIME register value as the next synchronization point in the instruction data assumed when the instruction data is received and the current register value of its own CYCLE_TIME register value, and detects a time as a synchronization point when the count value reaches a predetermined value. As a result, all the stations are kept synchronous even when the communication period between the master and the slave is an integral multiple a base cycle, by using a method different from the second invention.

A fourth invention described in claim 4 provides the master/slave synchronization communication system wherein as a separate detecting section for the synchronization point, the master determines an arbitrary base cycle as a synchronization point, sets the base cycle counter value to a predetermined value, and transmits the present base cycle counter value to each slave when the master transmits an instruction to the each slave, and each of the slaves sets the base cycle counter value to its own base cycle counter, and detects a time as a synchronization point when the count value reaches a predetermined value. As a result, all the stations are kept synchronous even when the communication period between the master and the slave is an integral multiple a base cycle, by using a method different from claims 2 and 3 of the invention.

A fifth invention described in claim 5 provides the master/slave synchronization communication system wherein as a separate detecting section for the synchronization point, the master detects a synchronization point based on CYCLE_TIME register value, and simultaneously sets the base cycle counter value to a predetermined value, and each of the slaves detects a synchronization point based on the CYCLE_TIME register value by way of the same way as the master, and simultaneously sets the base cycle counter value to a predetermined value. As a result, all the stations are kept synchronous even when the communication period between the master and the slave is an integral multiple a base cycle, by using a method different from the second through four inventions.

By detecting a synchronization point and executing transmission in accordance with a transmission schedule pre-registered in the transmission management table in synchronization with the synchronization point, data transmission/reception between a master and slaves is allowed even when the communication period between the master and a slave is an integral multiple a base cycle.

### ADVANTAGES OF THE INVENTION

As mentioned above, according to the invention, it is possible to use a natural period as a base cycle and synchronize base cycle counters for counting the number of cycles across all stations to implement a communication period that is an integral multiple of the natural period. By scheduling the transmission timing of instruction data from the master to slaves and response data from a slave to the master based on the synchronized base cycle counter value, it is possible to provide a master/slave synchronization communication system capable of transmitting data while synchronizing all stations with a communication period that is an integral multiple of the natural period in a real-time control system to which IEEE1394 is applied.

For example, by using the method shown in FIG. 3 and setting a transmission management table and transmission timing information so that the transmission timing of instruction data from the master to slaves and the transmission timing of response data from a slave to the master are paired and data is transmitted/received in the same base cycle, it is possible to perform scheduling of a polling system equivalent to PROFIBUS-DP in the related art shown in FIG. 12 on the communication traffic in each base cycle in a communication period.

For example, by using the method shown in FIG. 4 and setting a transmission management table and transmission timing information so that the transmission timing of response data from each slave to the master is in a separate base cycle delayed from reception of instruction data from the master to each slave, it is possible to perform scheduling of in each base cycle of the communication period in accordance with SERCOS as shown in FIG. 13.

Also for cases other than those in FIGS. 3 and 4 it is possible to readily implement desired master/slave synchronization communications by setting the transmission management table on the master side and the transmission timing information on the slave side.

### BRIEF DESCRIPTION OF THE DRAWINGS

FIG. 1 is a system block diagram where IEEE1394 is applied in a fourth embodiment of the invention;

FIG. 2 shows an example of implementation of a master transmission management table and slave transmission timing information in an embodiment of the invention;

FIG. 3 is a communication timing chart in a second embodiment of the invention;

FIG. 4 is a communication timing chart in a third embodiment of the invention;

FIG. 5 is a CYCLE_TIME register of IEEE1394;

FIG. 6 is a flowchart of master instruction transmission processing in a first embodiment of the invention;

FIG. 7 is a flowchart of slave response transmission processing in the first embodiment of the invention;

FIG. 8 is a flowchart of the operation of a synchronization point detecting section of a slave in the second embodiment of the invention;

FIG. 9 is a flowchart of the operation of the synchronization point detecting section of a slave in the third embodiment of the invention;

FIG. 10 is a flowchart of the operation of the synchronization point detecting section of a slave in the fourth embodiment of the invention;

FIG. 11 is a flowchart of the operation of the synchronization point detecting section of a master and a slave in a fifth embodiment of the invention;

FIG. 12 is a communication timing chart showing an example of a related art method; and

FIG. 13 is a communication timing chart showing an example of another related art method.

### DESCRIPTION OF THE REFERENCE

1 Master
21 Slave
3 Transmission path of IEEE1394
10j CYCLE_TIME register
11j Cycle_synch
12j Base cycle counter
130 Transmission management table
14j Synchronization point detecting section
150 Instruction transmission processing
23i Transmission timing information
25i Response transmission processing
ci Instruction data from slave #i
ri Response data to slave #i
where i=1, 2, . . . n (“n” is an integer of 1 or more.) j=0, 1, 2, . . . n (“n” is an integer of 1 or more.)

### DETAILED DESCRIPTION OF THE PREFERRED EMBODIMENTS

Specific embodiments of the invention will be described based on drawings.

### First Embodiment

First of all, feature names and signal names specified in the IEEE1394 Standard that appear in the following description will be described. As shown in FIG. 5, the CYCLE_TIME resister is composed of a cycle_offset part, a cycle_count part and a second_count part. The cycle_offset part counts a clock of 24.576 Hz in each station. When the count reaches 3072, the cycle_offset part outputs a carry every 125 μs of a natural period. The cycle_count part counts carries from the cycle_offset part. When the count reaches 8000, the cycle_offset part outputs a carry every 1 s. Cycle_sync is a synchronization signal issued every 125 μs of a natural period.

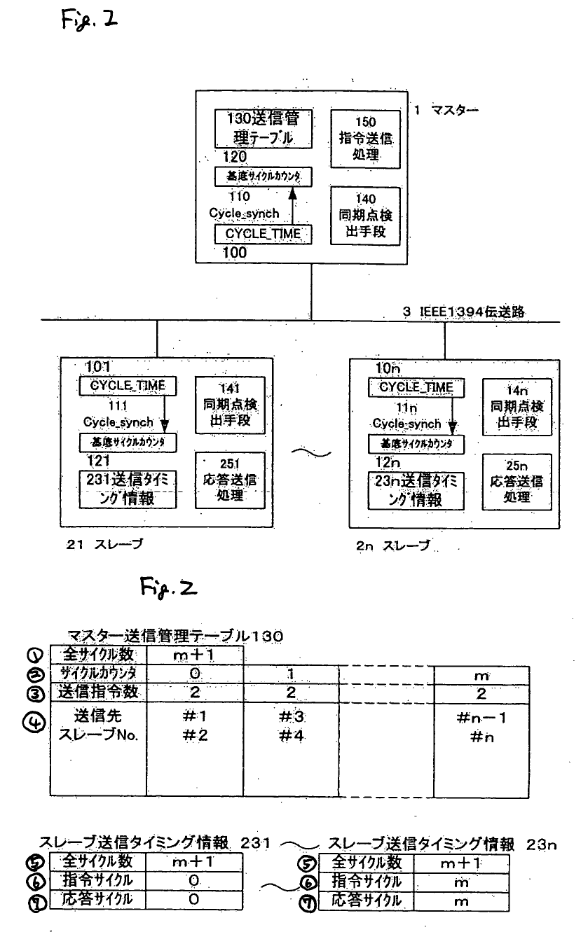

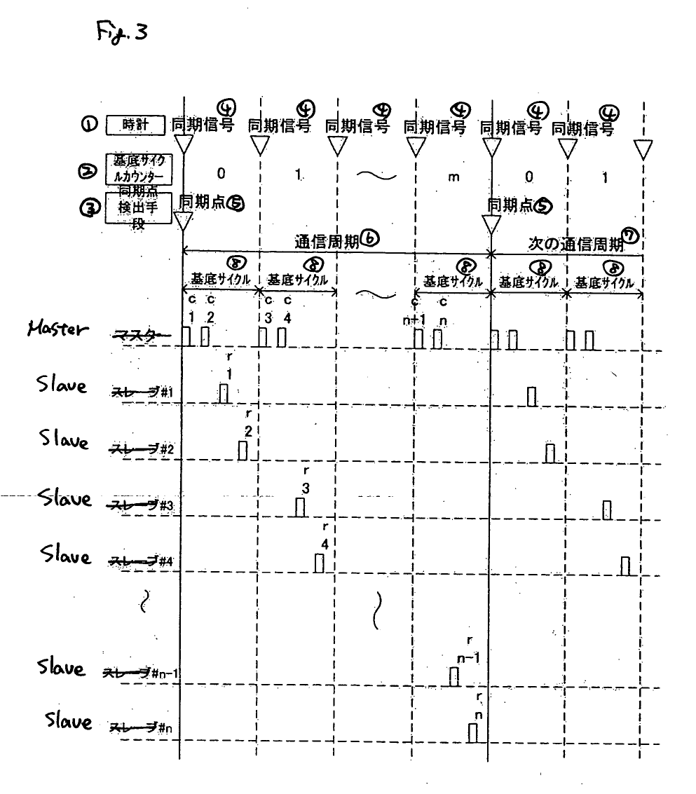

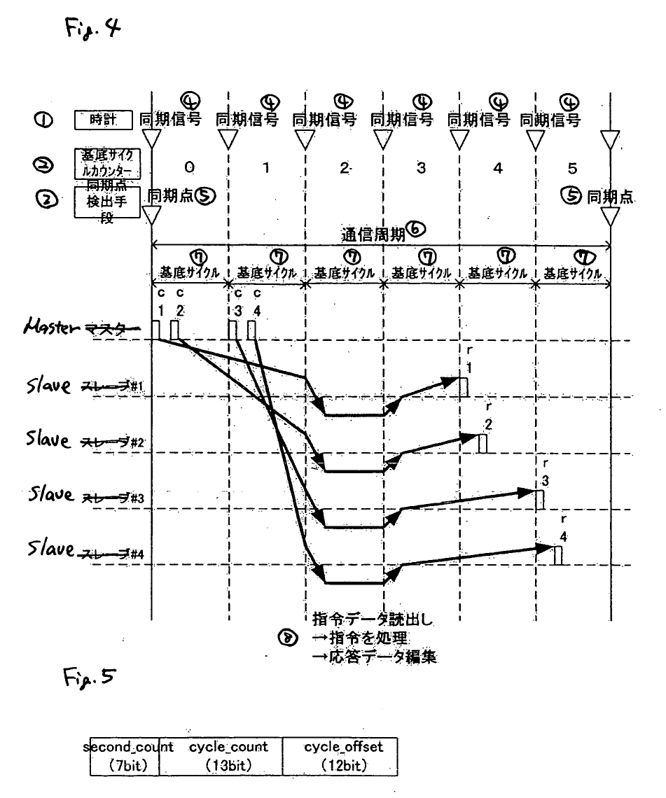

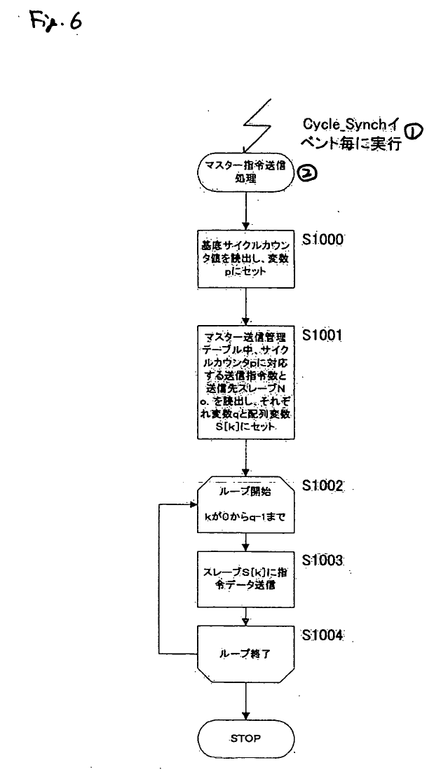

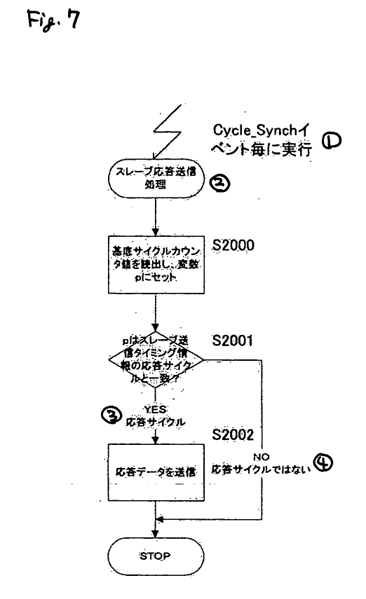

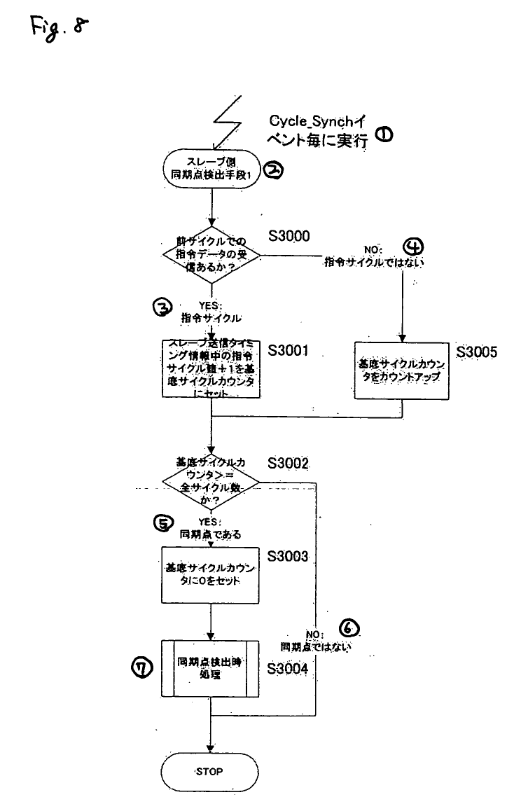

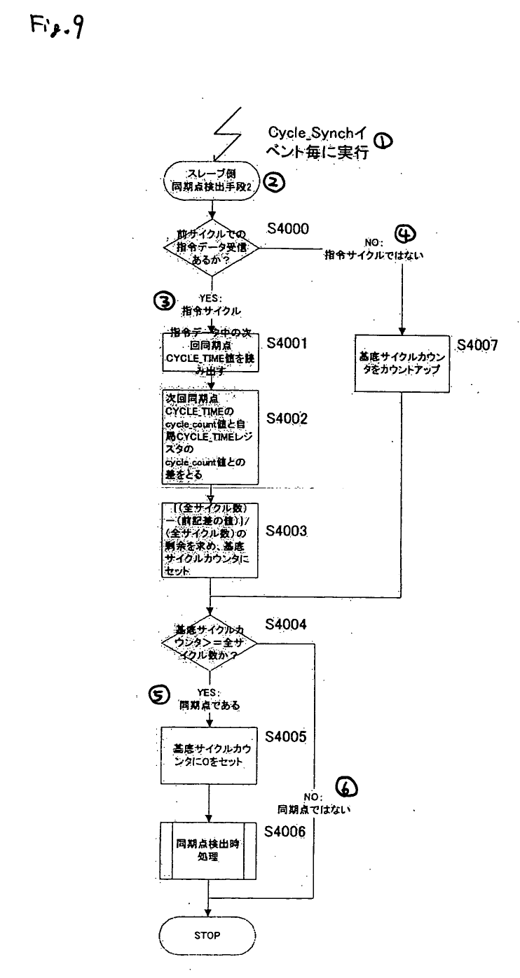

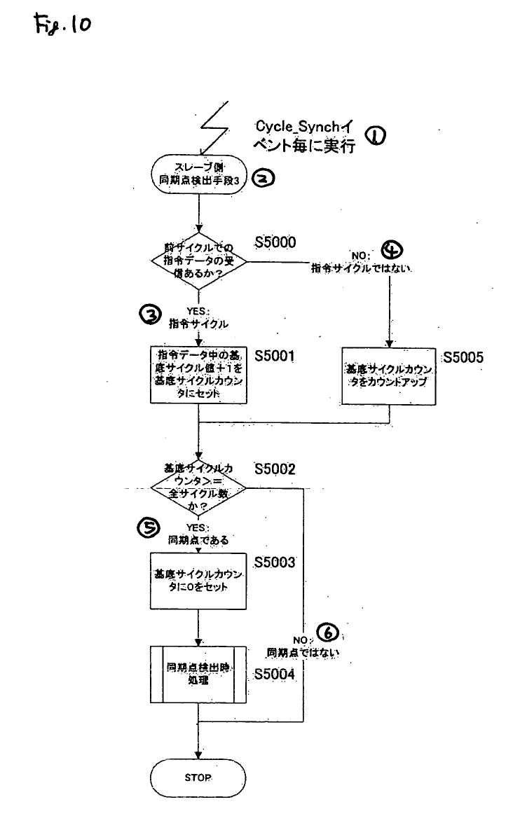

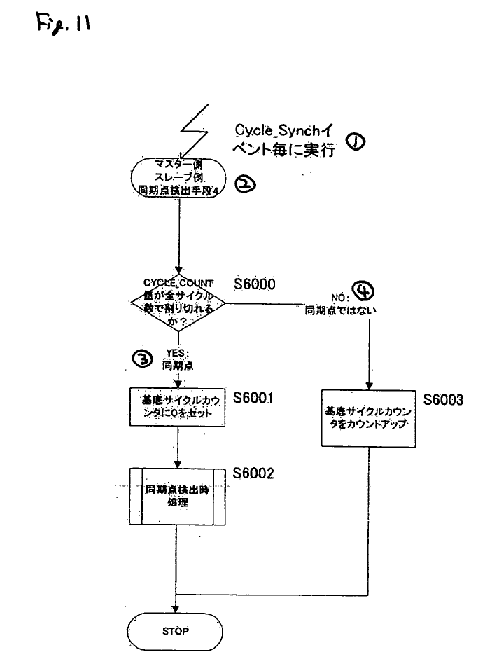

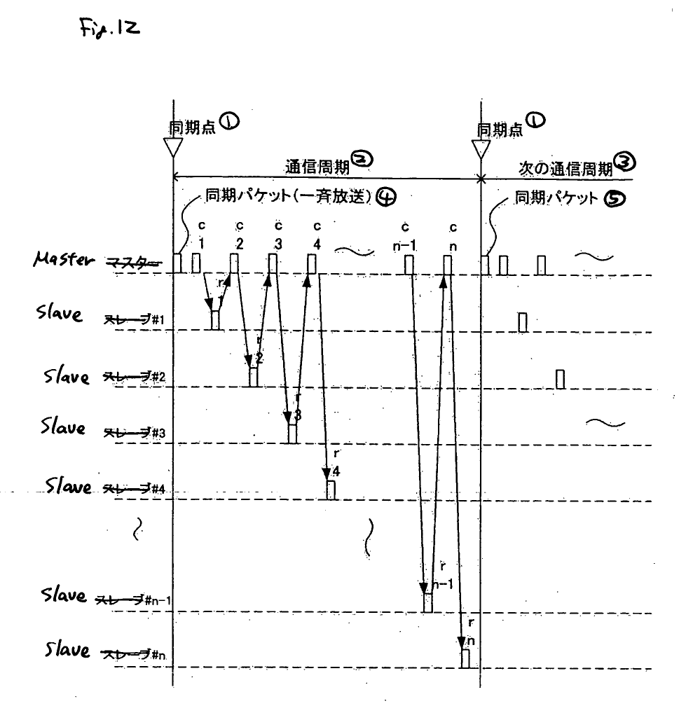

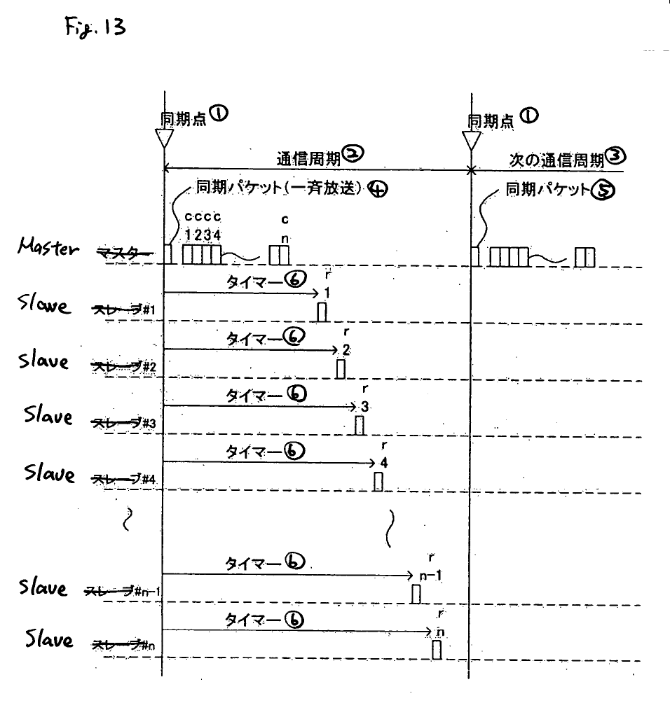

FIG. 1 shows a specific embodiment of the first invention where reference 1 represents a master, reference 2i (i=1, 2, . . . n) represents a slave, and reference 3 represents a transmission path of IEEE1394. Reference 10j (j=0, 1, . . . n) represents a CYCLE_TIME register serving as a clock part of the master and each slave. From the CYCLE_TIME register 10j, Cycle_Synch 11j as a synchronization signal is output per natural period to count up the base cycle counter 12j. Cycle_Synch 11j also serves as an execution timing for a synchronization point detecting section 14j.

The synchronization point detecting section 14j thus detects a synchronization point every time the base cycle counter is counted up and resets the base cycle counter value to 0 in case a synchronization point is detected. With this, the values of the base cycle counters of all stations on a field network system may count up in synchronization.

The master 1 owns a transmission management table 130. Based on the information from the transmission management table 130, an instruction transmission processing 150 transmits an instruction. Each slave i owns transmission timing information 23i and a response transmission processing 25i transmits response data based on this information.

FIG. 2 shows an embodiment of the transmission management table 130 on the master side and transmission timing information 23i on each slave. The transmission management table on the master side stores destination slaves to which an instruction is to be transmitted for each base cycle value. The transmission timing information on each slave stores a base cycle value for which an instruction is to be received from the master and a response is to be returned to the master.

FIG. 6 shows a processing flow of the instruction transmission processing 150 on the master side in FIG. 1 of the first embodiment. FIG. 7 shows a processing flow of the response transmission processing 25i on the slave side. Data transmission/reception according to the first invention will be sequentially described.

As shown in FIG. 6, the master instruction transmission processing 150 is activated by Cycle_synch 110 per natural period and sets the value of a base cycle counter 120 to a read variable p at S1000. Next, at S1001, the master instruction transmission processing 150 sets the transmission instruction number as row data whose cycle counter value in the master transmission management table 130 corresponds to the variable p to the variable q and sets the list data of a corresponding destination slave number to an array variable S[k] (K=0, 1, . . . , q-1). Then execution proceeds to loop processing between S1002 and S1004. At S1003 the master instruction transmission processing 150 transmits instruction data to a slave S[k]. In this way, operation may be such that every time the value of the base cycle counter 120 is updated, instruction data is transmitted to all slaves 2i to which transmission is scheduled in the cycle.

As shown in FIG. 7, the slave response transmission processing 25i is activated by Cycle_synch per natural period and sets the value of a base cycle counter 12j to the read variable p at S2000. Next, the slave response transmission processing 25i compares the response cycle value in the transmission timing information 23i with the variable p and, in case a match is found, transmits response data because the cycle is a response cycle. Otherwise, the slave response transmission processing 25i does not transmit response data because the cycle is not a response cycle. In this way, it is possible to operate so as to transmit response data every time a pre-scheduled value of the base cycle counter 12i is reached.

As such, it is possible for the master 1 and slaves 2i to perform communications in synchronization with respective scheduled timings in accordance with the value of the base cycle counter 12j.

FIG. 3 is a communication timing chart where the transmission/reception table and transmission timing information are scheduled so as to complete transmission/reception in the same base cycle. By properly setting the master transmission management table 130 and the slave transmission timing information 23i and for example assuming destination slave No. in the row of the cycle counter value 0 in the master transmission management table 130 as #1, #2, destination slave No. 3 in the row of the cycle counter value 1 as #3, #4 as well as setting each response cycle value of the transmission timing information 23i in the slaves #1, #2 to 0 and setting each response cycle value of the transmission timing information 23i in the slaves #3, #4 to 1, instruction data to the slaves #1 and #2 is transmitted when the value of the base cycle counter 12j is 0 and response data from the slaves #1 and #2 is returned. Similarly, it is possible to transmit/receive instruction data and response data as a data pair of an arbitrary slave 2i in the same base cycle.

FIG. 4 is a communication timing chart where the transmission/reception table and transmission timing information are scheduled so as to transmit a response in the same base cycle. By properly setting the master transmission management table 130 and the slave transmission timing information 23i and for example assuming destination slave No. in the row of the cycle counter value 0 in the master transmission management table 130 as #1, #2, destination slave No. 3 in the row of the cycle counter value 1 as #3, #4 as well as setting each response cycle value of the transmission timing information 23i in the slaves #1, #2 to 4 and setting each response cycle value of the transmission timing information 23i in the slaves #3, #4 to 5, instruction data to the slaves #1 and #2 is transmitted when the value of the base cycle counter 12j is 0 and response data from the slaves #1 and #2 is returned with a delay of four cycles, when the value of the base cycle counter 12j is 4. Similarly, scheduling may be made so that instruction data to the slaves #3 and #4 is transmitted when the value of the base cycle counter 12j is 1 and response data from the slaves #3 and #4 is returned with a delay of four cycles, when the value of the base cycle counter 12j is 5.

### Second Embodiment

Next, an embodiment of the synchronization point detecting section 14j that synchronizes the updates of the base cycle counter 12j will be described. As a matter of fact, detection of a synchronization point is made individually for the master 1 and each slave 2i and the result is reflected on the value of the base cycle counter 12j of each station. A cycle that serves as its synchronization point requires the same determination result by all stations. While the value of the base cycle counter 12j is 0 at this synchronization point and thereafter the value of the base cycle counter 12j is incremented every time a base cycle elapses, that is, the Cycle_synch event 11j takes place and the value of the base cycle counter 12j returns to 0 at the next synchronization point after a predetermined communication period has elapsed in this embodiment, transition of the value of the base cycle counter 12j is not limited thereto but the value may be decremented. A base cycle counter value at a synchronization point need not be 0 as long as it is a specified value.

A second invention that is a specific method of the synchronization point detecting section 14j will be described. In a synchronization point detection processing 140 of the master 1, a synchronization point detecting section is activated by a Cycle_synch event 11j per natural period and only increments the base cycle counter 120 and determines whether the value is 0.

Processing at each slave 2i will be described in line with FIG. 8. First, the processing determines whether instruction data from the master 1 is received in the last base cycle at S3000. In case the data is received, recognizing that the last base cycle is an instruction cycle in the transmission timing information, the processing sets the value of an instruction cycle value plus 1 as a current base cycle counter value. Otherwise, the processing increments the base cycle counter 12j at S3005. In case the base cycle counter value updated for wraparound determination is equal to or more than the total number of cycles in the transmission timing information 23i at S3002, the processing resets the count value to 0 at S3003. Recognizing that the current cycle is a synchronization point, the processing performs necessary synchronization point detection processing at S3004.

### Third Embodiment

A third invention that is another method for the synchronization point detection processing 14j will be described. In a synchronization point detection processing 140 of the master 1, a synchronization point detecting section is activated by a Cycle_synch event 11j per natural period and only increments the base cycle counter 120 and determines whether the value is 0. The instruction data transmitted from the master to each slave in accordance with the transmission management table includes the CYCLE_TIME register value at the next synchronization point.

Processing at each slave 2i will be described in line with FIG. 9. First, the processing determines whether instruction data from the master 1 is received in the last base cycle at S4000. In case the data is received, the processing extracts at S4001 the CYCLE_TIME register value as the next synchronization point in the received instruction data. Next, at S4002, the processing obtains the difference between the cycle_count value of the current CYCLE_TIME register and the cycle_count value of the next synchronization point CYCLE_TIME register in the instruction data. At S4003, the processing obtains the residue of the result of dividing {(total number of cycles in the slave transmission timing information 23i)—(the difference) by (total number of cycles in the slave transmission timing information 23i) and sets the obtained value as a current base cycle counter value. For example, in case the cycle_count value of the next synchronization point CYCLE_TIME register is 45, the cycle_count value of the current CYCLE_TIME register is 43, and total number of cycles is 6, {6−(45−43)}÷6=residue of 4÷6=4. The value 4 is set to the base cycle counter. Otherwise, the processing increments the base cycle counter 12j at S4007. In case the base cycle counter value updated for wraparound determination is equal to or more than the total number of cycles in the transmission timing information 23i at S4004, the processing resets the count value to 0 at S4005. Recognizing that the current cycle is a synchronization point, the processing performs necessary synchronization point detection processing at S4006.

### Fourth Embodiment

A fourth invention that is another method for the synchronization point detection processing 14j will be described. In a synchronization point detection processing 140 of the master 1, a synchronization point detecting section is activated by a Cycle_synch event 11j per natural period and only increments the base cycle counter 120 and determines whether the value is 0. The instruction data transmitted from the master to each slave in accordance with the transmission management table includes the then master base cycle counter value.

Processing at each slave 2i will be described in line with FIG. 10. First, the processing determines whether instruction data from the master 1 is received in the last base cycle at S5000. In case the data is received, the processing sets the value of a base cycle value included in the instruction data plus 1 to the base cycle counter of the slave. Otherwise, the processing increments the base cycle counter 12j at S5005. In case the base cycle counter value updated for wraparound determination is equal to or more than the total number of cycles in the transmission timing information 23i at S5002, the processing resets the count value to 0 at S5003. Recognizing that the current cycle is a synchronization point, the processing performs necessary synchronization point detection processing at S5004.

### Fifth Embodiment

A fifth invention that is another method for the synchronization point detection processing 14j will be described referring to FIG. 11. In a synchronization point detection processing 140 of the master 1, a synchronization point detecting section is activated by a Cycle_synch event 11j per natural period. The synchronization point detection processing 14j determines whether the cycle_count value of the CYCLE_TIME register is divisible by the total number of base cycles necessary for a communication period. In case it is divisible, the synchronization point detection processing 14j assumes a synchronization point, sets the base cycle counter value to 0 at S6001 and performs necessary synchronization point detection processing at S6002. Otherwise, the synchronization point detection processing 14j determines that the current cycle is not a synchronization point and increments the cycle_count value of the CYCLE_TIME register at S6003. Instead of incrementing the base cycle, the synchronization point detection processing 14j may set the residue of the result of dividing the cycle_count value of the CYCLE_TIME register by the total number of cycles of base cycles necessary for a communication period to the base cycle counter.

The each slave can detect a synchronization point by using the same way as the master based on the CYCLE_TIME register value of each slave.

### INDUSTRIAL APPLICABILITY

In this way, it is possible to implement a real-time control system capable of master/slave synchronization communications by using IEEE1394 for communications between a master and a slave, the real-time control system including a master 1 shown in FIG. 1 as a controller and a slave 2i as a device controlled by the controller in a fixed period. As a specific example, there is provided a motion control system where the master is composed of motor drive devices such as a motion controller.

What is claimed is:

1. A master/slave synchronization communication system, comprising:
a single master and a single or a plurality of slaves that are based on IEEE1394,
wherein the master/slave synchronization communication system has a communication period which is set to an integral multiple of a natural period of IEEE1394 communications with the natural period considered as a base cycle,
each of the master and the slaves has a detecting section of a synchronization point being a start timing of the communication period, and a base cycle counter which shows what base cycle number the present cycle is from the synchronization point,
the master has a transmission management table in which destination slaves of instruction data are previously allocated to each of the base counter values, and transmits instruction data to each slave every time the base cycle counter is updated based on the transmission management table, and
each of the slaves transmits response data to the master when the pre-allocated value of the base cycle counter is reached.

2. The master/slave synchronization communication system according to claim 1,
wherein as the detecting section of the synchronization point,
the master determines an arbitrary base cycle as a synchronization point, and transmits instruction data to each slave based on the base cycle, and
each of the slaves corrects a current value of the base cycle counter based on the base cycle counter value assumed when the instruction data is received and the pre-allocated base cycle counter value assumed when the instruction data is received, and detects a time as a synchronization point when the count value reaches a predetermined value.

3. The master/slave synchronization communication system according to claim 1,
wherein as the detecting section of the synchronization point,
the master determines an arbitrary base cycle as a synchronization point, and writes CYCLE_TIME register value as the next synchronization point in the instruction data when the master transmits instruction data to each slave based on the base cycle, and
each of the slaves corrects a current value of the base cycle counter value based on the CYCLE_TIME register value as the next synchronization point in the instruction data assumed when the instruction data is received and the current register value of its own CYCLE_TIME register value, and detects a time as a synchronization point when the count value reaches a predetermined value.

4. The master/slave synchronization communication system according to claim 1,
wherein as the detecting section of the synchronization point,
the master determines an arbitrary base cycle as a synchronization point, sets the base cycle counter value to a predetermined value, and transmits the present base cycle counter value to each slave when the master transmits an instruction to the each slave, and
each of the slaves sets the base cycle counter value to its own base cycle counter, and detects a time as a synchronization point when the count value reaches a predetermined value.

5. The master/slave synchronization communication system according to claim 1,
wherein as the detecting section of the synchronization point,
the master detects a synchronization point based on CYCLE_TIME register value, and simultaneously sets the base cycle counter value to a predetermined value, and
each of the slave detects a synchronization point based on the CYCLE_TIME register value by way of the same way as the master, and simultaneously sets the base cycle counter value to a predetermined value.
